(19) United States
(12) Patent Application Publication
(10) Pub. No.: US 2020/0116749 A1
(43) Pub. Date: Apr. 16, 2020

(54) LOCK COMMANDS FOR DISPENSERS

(71) Applicant: HEWLETT-PACKARD DEVELOPMENT COMPANY, L.P., Spring, TX (US)

(72) Inventor: David H. OCHS, Corvallis, OR (US)

(21) Appl. No.: 16/603,939

(22) PCT Filed: Sep. 27, 2017
(86) PCT No.: PCT/US17/53730

§ 371 Date: Oct. 9, 2019

(51) Int. Cl. G01N 35/10; G01N 35/00

(52) U.S. Cl. CPC G01N 35/1016; G01N 2035/0091; G01N 2035/1023; G01N 35/00722

(57) ABSTRACT

In example implementations, a method is provided. The method may be executed by a processor of a fluid dispensing apparatus. The method includes receiving a request to lock a plurality of dispensers in the fluid dispensing apparatus. A confirmation is detected that each one of the plurality of dispensers is filled with a respective fluid. An unlock command is received to allow each one of the plurality of dispensers to dispense the respective fluid. The respective fluid is dispensed in accordance with the unlock command.

### BACKGROUND

Laboratories often run experiments using various different liquids to obtain different types of experimental data. The experiments may use fluid dispensers that dispense fluid into microplates or microtiter plates to perform the various different experiments.

The fluid dispensers may dispense fluids using a cassette that contains a plurality of dispense heads. Each dispense head may be filled with the same or different fluids. The fluid dispensers may control the cassette and the dispense heads to dispense fluid on desired locations in a well of a microplate or on layers of bio-matter that may be grown on slides. Some examples of cassettes may include thermal inkjet cassettes that have been modified to dispense different types of fluids instead of ink used for printing.

### BRIEF DESCRIPTION OF THE DRAWINGS

FIG. 1 is a block diagram of an example apparatus of the present disclosure;

FIG. 2 illustrates an example screenshot of a graphical user interface (GUI) of the present disclosure;

FIG. 3 illustrates another example screenshot of the GUI of the present disclosure;

FIG. 4 is a flow chart of an example method for controlling a; and

FIG. 5 is a block diagram of an example non-transitory computer readable storage medium storing instructions executed by a processor.

### DETAILED DESCRIPTION

Examples described herein provide an apparatus and a method for controlling a dispenser. Current dispensers (e.g., a dispense heads in a cassette) may begin dispensing fluid from a dispenser as soon as the dispenser is filled. However, in some instances, a customer may want to delay dispensing or control a timing of the dispensing of different fluids for different reasons.

Examples described herein provide a fluid dispensing apparatus that allows a user to control a dispenser used to dispense fluid in the fluid dispensing apparatus. For example, the user may lock each dispenser (e.g., a dispense head in a cassette, a digital pipette system, and the like), or selectively lock some dispensers, before filling each dispenser with fluid. The user may be prompted to fill each dispenser and confirm that each dispenser was filled through a graphical user interface (GUI) of the fluid dispensing apparatus. The user may then unlock all of the dispensers for dispensing fluids, or choose an order that the dispensers will be unlocked and begin dispensing.

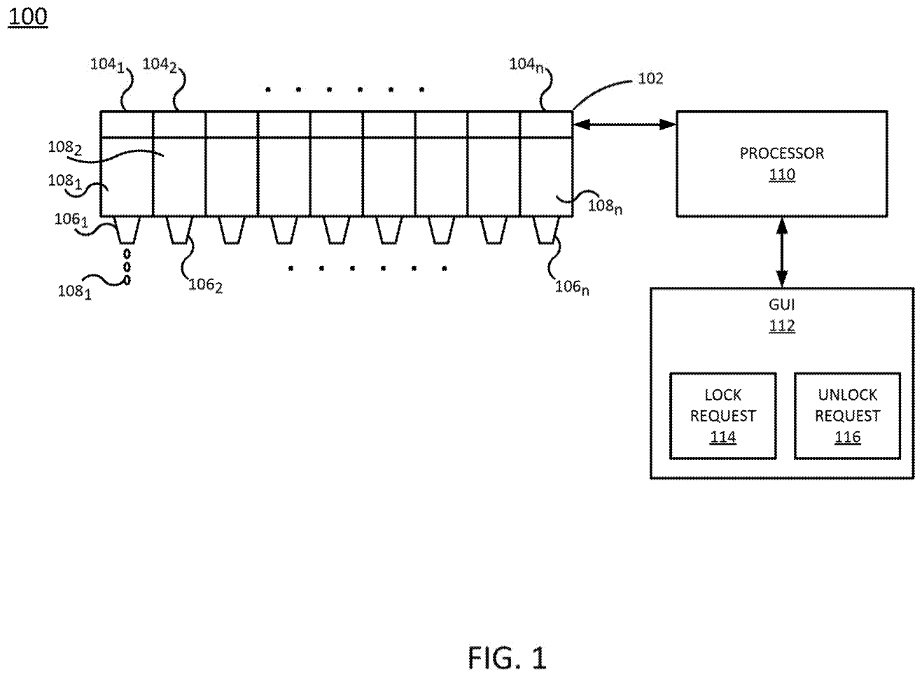

FIG. 1 illustrates a block diagram of an example fluid dispensing apparatus 100 of the present disclosure. In one example, the fluid dispensing apparatus may include a dispenser 102. The dispenser 102 may be movably connected in the fluid dispensing apparatus 100, For example, the dispenser 102 may move along a single axis, or a two dimensional axis over a surface. The surface may be any type of surface such as a microplate with a plurality of wells, an experimental surface, mounted paper, a surface with electronic sensors, and the like.

In one example, the dispenser 102 may be a cassette that includes at least one dispense head 104₁ to 104ₙ (herein also referred to collectively as dispense heads 104 or individually as a dispense head 104). The dispense heads 104₁ to 104ₙ may include respective nozzles 106₁ to 106ₙ (herein also referred to collectively as nozzles 106 or individually as a nozzle 106) and respective fluids 108₁ to 108ₙ (herein also referred to collectively as fluids 108 or individually as a fluid 108). It should be noted that although a plurality of dispense heads, nozzles and fluids are illustrated in FIG. 1, that a single dispense head, a single nozzle and a single fluid may also be deployed.

Although the examples disclosed below use a dispense head 104, it should be noted that the dispenser 102 may be a digital pipette system, an acoustic dispensing system, a pressure based dispensing system, a metering fluid dispense system, or any other type of dispenser. Thus, the examples described below that use a dispense head may be equally applicable to other types of dispensers.

In one example, the dispenser 102 may be a thermal inkjet printhead. For example, the thermal inkjet printhead traditionally used to dispense ink in a printer may be modified to deliver and dispense the fluids 108.

In one example, each dispense head 104 may dispense a respective fluid 108 onto a surface located above, or below, the dispenser 102. The fluid may be any type of aqueous based compound, such as aqueous based compounds with optional surfactant or glycerol that is added, dimethyl sulfoxide (DMSO) based compounds, and the like). In one example, each dispense head 104 may have the same fluid 108 or have different fluids 108.

In one example, a processor 110 may be communicatively coupled to the dispenser 102. The processor 110 may control each dispense head 104. For example, the processor 110 may control when each dispense head 104 dispenses a respective fluid 108, a frequency at which each dispense head 104 dispenses a respective fluid 108, an amount of a respective fluid 108 that is dispensed by each dispense head 104, a sequence that each dispense head 104 dispenses a respective fluid 108, and the like.

The processor 110 may also be communicatively coupled to a graphical user interface (GUI) 112. The processor 110 may control display of images and prompts on the GUI 112 (e.g., via a graphics processor not shown). The processor 110 may also receive inputs from a user via the GUI 112. For example, the GUI 112 may be a touch screen interface or may work with an external keyboard and mouse (not shown) to receive inputs.

In one example, the processor 110 may receive a lock command (or lock request) 114 and an unlock command (or unlock request) 116 via the GUI 112. As discussed above, a user may sometimes wish to control dispensing of the fluids 108 from the dispense heads 104. For example, currently as soon as a dispense head 104 is filled with a fluid 108, the dispense head may immediately begin dispensing fluid 108. However, a user may want to prevent immediate dispensing of the fluid 108 after a dispense head 104 is filled for different reasons. In another example, the lock command 114 and the unlock command 116 may be received via a physical button. For example, the physical button may be part of a control panel that sends electronic signals to the processor 110.

In addition, the user may want to use the prompts and confirmation inputs for each dispense head 104 displayed by the GUI 112. The prompts may help to ensure that the user is filling the correct dispense head 104 and helps to prevent errors. Thus, the present disclosure allows a user to provide the lock request 114 and the unlock request 116 to control when the dispense heads 104₁ to 104ₙ begin dispensing after being filled with the respective fluids 108₁ to 108ₙ.

In one example, the lock request 114 may be a single request for all of the dispense heads 104. In another example, the lock request 114 may comprise a plurality of different lock requests 114 for selected dispense heads 104₁ to 104ₙ. For example, the user may want to lock four out of eight dispense heads 104.

In response to the lock request 114, the processor 110 may prevent the dispense heads from dispensing a respective fluid 108 after being filled. For example, the processor 110 may control the dispense heads 104 to lock them during the filling process. In one example, the processor 110 may lock a selected dispense head or dispense heads when separate lock requests 114 are used for each dispense head 104.

In one example, the unlock request 116 may be a single request that releases all of the dispense heads 104 for dispensing. In another example, the unlock request 116 may comprise a plurality of different unlock requests 116 for selected dispense heads 104₁ to 104ₙ. For example, the user may want to unlock the dispense heads in a particular sequence (e.g., first dispense head 104₃, then dispense head 104₅, then dispense head 104₇ and so forth) rather than a sequential order or another predefined order in accordance with a particular dispense protocol executed by the fluid dispensing apparatus 100.

In response to the unlock request 116, the processor 110 may release the dispense heads 104 to allow the dispense heads to dispense the respective fluids. For example, the processor 110 may allow the dispense heads to dispense the respective fluids in accordance with a dispense protocol. In one example, the processor 110 may release a selected dispense head or dispense heads when separate unlock requests 116 are used for each dispense head 104. For example, the processor 110 may release the selected dispense heads in a sequence that the unlock requests 116 for the selected dispense heads are received.

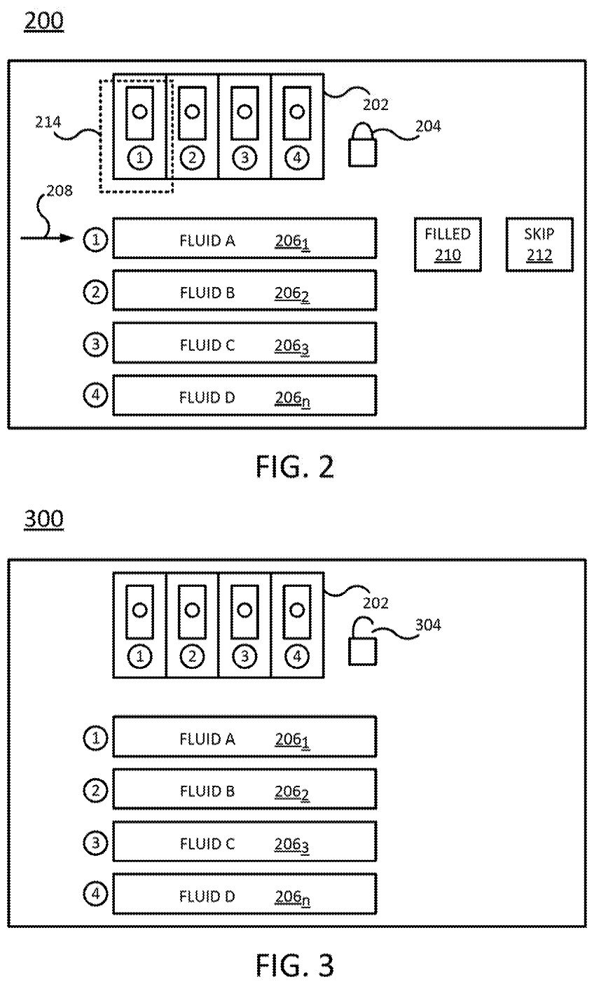

FIG. 2 and FIG. 3 illustrate screenshots 200 and 300, respectively, of the GUI 112. In one example, the screenshot 200 illustrates the GUI displaying a representative image 202 of the dispense heads 104 in the dispenser 102. Although four dispense heads are illustrated in the representative image 202, it should be noted that any number of dispense heads may be illustrated (e.g., one or many).

The screenshot 200 illustrates a locked icon 204 that indicates the unlock request 114 has been received. Although a single locked icon 204 is illustrated in FIG. 2, it should be noted that a plurality of locked icons 204 may also be deployed (e.g., one locked icon displayed over each dispense head in the representative image 202) As noted above, when the locked icon 204 is displayed, the dispense heads may be locked until all of the dispense heads are filled with the respective fluid. In other words, the dispense heads will not begin dispensing immediately after being filled.

The screenshot 200 also may include a listing of fluids 206₁ to 206ₙ that are used to fill each dispense head. The number of fluids that are listed may be equal to the number of dispense heads shown in the representative image 202.

An indicator 208 may be used to indicate which dispense head is currently being filled. Although an arrow is illustrated as the indicator 208, it should be noted that any type of indicator may be used. For example, the indicator 208 may be bolding the lines and text, changing a color, animating a line and/or text, a different shape or icon, and the like.

In addition, an input button 210 and an input button 212 may be displayed for the dispense head that is currently being filled. The input button 210 may be a button to confirm that the dispense head has been correctly filled. For example, when the input button 210 is pressed (e.g., via a touch screen GUI or an external input device), an electronic signal may be generated that indicates the filling of the currently selected dispense head is complete. The electronic signal may be received by the processor 110 and the processor 110 may then move the indicator 208 to the next dispense head in the filling process.

The input button 212 may be a button to skip a selected dispense head due to a miss-fill. For example, the user may have miss-filled a dispense head and the input button 212 may allow the user to skip or invalidate the miss-filled dispense head. Although two input buttons 210 and 212 are illustrated in FIG. 2, it should be noted that any number of dispense buttons may be used and displayed in the GUI 112.

In one example, a highlight 214 may be used to also visually indicate on the representative image 202 which dispense head is currently being filled. The highlight 214 may be an outline, a shading, use of a different color, an animation (e.g., flashing the dispense head that is currently being filled), and the like. The highlight 214 may move as the currently selected dispense head is changed.

In one example, the fluid dispensing apparatus 100 may also include a physical indicator on the actual dispense head 104 that is currently being filled. For example, the physical indicator may be a colored light that may shine on the actual dispense head 104 that is currently being filled. In another example, the physical indicator may be a moving pointer, a physical shield that blocks an opening of the other dispense heads that are not currently being filled, and so forth.

In one example, the screenshot 300 illustrated in FIG. 3 may also include the representative image 202 and the listing of fluids 206₁ to 206ₙ that are used to fill each dispense head. However, the screenshot 300 may include an unlocked icon 304. The unlocked icon 304 may indicate that filling of the dispense heads may be completed and the unlock request 116 was received.

It should be noted that although a single unlocked icon 304 is illustrated in FIG. 3, any number of unlocked icons 304 may be displayed. For example, a plurality of unlocked icons 304 may be displayed (e.g., one unlocked icon 304 displayed over each dispense head in the representative image 202). The plurality of unlocked icons 304 may be used when a user selects a sequence to unlock the dispense heads for dispensing.

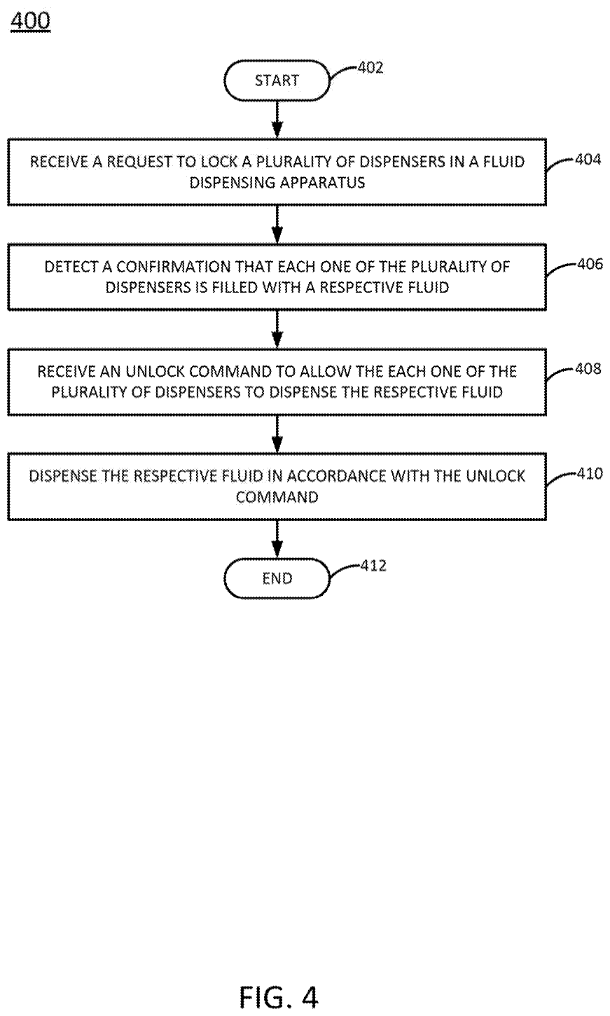

FIG. 4 illustrates a flow diagram of an example method 400 for controlling a dispenser. In one example, the method 400 may be performed by the processor of the fluid dispensing apparatus 100 or the processor 110 of the fluid dispensing apparatus 100.

At block 402, the method 400 begins. At block 404, the method 400 receives a request to lock a plurality of dispensers in a fluid dispensing apparatus. In one example, the request may be received via a GUI. The dispensers may be dispense heads in a cassette as described above, a digital pipette system, an acoustic dispensing system, a pressure based dispensing system, a metering fluid dispense system, or any other type of dispensing system.

In one example, the request to lock the plurality of dispensers may be a single request for all of the dispensers (e.g., each dispense head of the cassette). In another example, the request to lock the plurality of dispensers may be for a subset of all dispensers (e.g., the subset may be at least one dispense head of a plurality of dispense heads in a cassette). For example, all of the dispensers may not be used and the subset may include those dispensers that will be used. In another example, the subset of all of the dispensers may include those dispensers that are un-filled. For example, some dispensers may have been previously filled may not be filled again.

In one example, after the request to lock is received and implemented, a locked icon may be displayed in the GUI. The locked icon may indicate to the user that the request to lock is received and implemented.

At block 406, the method 400 detects a confirmation that each one of the plurality of dispensers is filled with a respective fluid. For example, after each dispenser is filled with the respective fluid, a user may press a confirmation button displayed on the GUI. An electronic signal may be generated in response to the confirmation button being selected to indicate that the selected dispenser is filled. In response, the GUI may highlight the next dispenser that is to be filled, and the process may be repeated.

At block 408, the method 400 receives an unlock command to allow the each one of the plurality of dispensers to dispense the respective fluid. In one example, the GUI may display an unlocked icon indicating to the user that the unlock command (e.g., a request to unlock) was received.

At block 410, the method 400 dispenses the respective fluid in accordance with the unlock command. For example, the dispensers may dispense the respective fluids in accordance with the dispense protocol or a sequence of unlock commands that was received for each dispense head. At block 412, the method 400 ends.

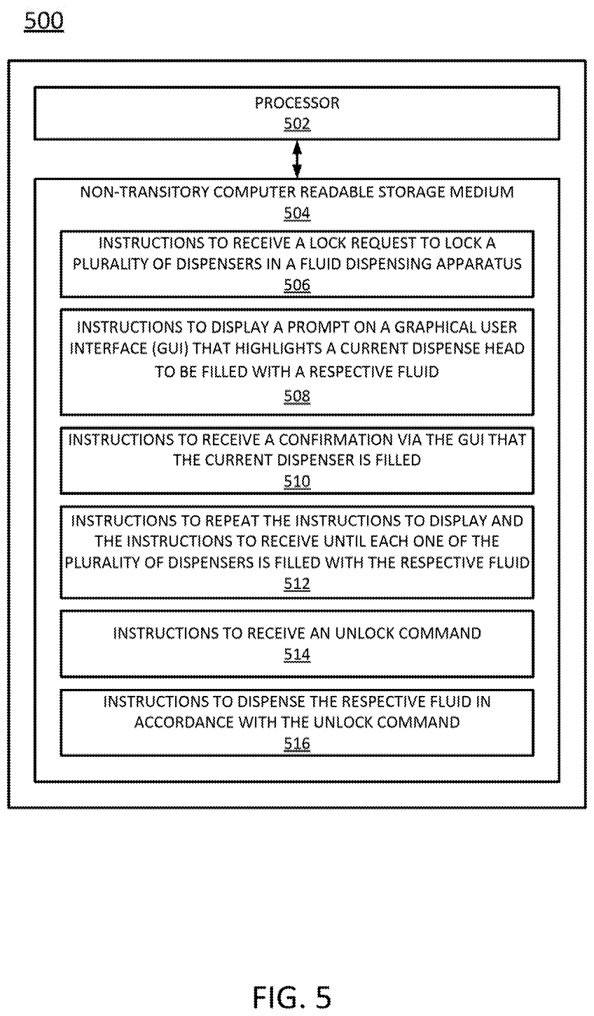

FIG. 5 illustrates an example of an apparatus 500. In one example, the apparatus 500 may be the fluid dispensing apparatus 100. In one example, the apparatus 500 may include a processor 502 and a non-transitory computer readable storage medium 504. The non-transitory computer readable storage medium 504 may include instructions 506, 508, 510, 512, 514 and 516 that, when executed by the processor 502, cause the processor 502 to perform various functions.

In one example, the instructions 506 may include instructions to receive a lock request to lock a plurality of dispensers in a fluid dispensing apparatus. For example, a user may want to prevent the dispensers (e.g., dispense heads) from dispensing fluid immediately after being filled.

The instructions 508 may include instructions to display a prompt on a graphical user interface (GUI) that highlights a current dispenser to be filled with a respective fluid. For example, the highlight may help ensure that the user is filling the correct dispenser.

The instructions 510 may include instructions to receive a confirmation via the GUI that the current dispenser is filled. For example, after the user finishes filling the dispenser, the user may select a confirmation button on the GUI. In response, an electronic signal may be generated that causes the fluid dispensing apparatus to cycle to the next dispenser for filling with a respective fluid. In addition, the highlighting may be moved to the next dispenser in the GUI.

The instructions 512 may include instructions to repeat the instructions to display and the instructions to receive until each one of the plurality of dispensers is filled with the respective fluid. For example, if there are four dispensers, the instructions 508 and 510 may be repeated four times.

The instructions 514 may include instructions to receive an unlock command. For example, after the dispensers are filled with respective fluids, the user may enter a unlock command (e.g., a request to unlock) via the GUI. The request to unlock may release the dispenser to dispenses the respective fluids.

The instructions 516 may include instructions to dispense the respective fluids in accordance with the unlock command. In one example, the unlock command may be a single request to unlock that releases all of the dispensers to dispense the respective fluids in accordance with the dispense protocol. In another example, the unlock command may include a plurality of requests to unlock one dispenser at a time and the dispensers may be released to dispense respective fluids in a sequence that the requests to unlock are received for the selected dispense heads.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
receiving, by a processor, a request to lock a plurality of dispensers in a fluid dispensing apparatus;
detecting, by the processor, a confirmation that each one of the plurality of dispensers is filled with a respective fluid;
receiving, by the processor; an unlock command to allow the each one of the plurality of dispensers to dispense the respective fluid;
dispensing, by the processor, the respective fluid in accordance with the unlock command.

2. The method of claim 1, wherein the request to lock the plurality of dispensers comprises all dispensers.

3. The method of claim 1, wherein the request to lock the plurality of dispensers comprises a subset of all dispensers.

4. The method of claim 1, wherein the detecting the confirmation is performed via an input received via a graphical user interface (GUI).

5. The method of claim 4, wherein the GUI displays an icon showing that the plurality of dispensers are locked.

6. The method of claim 1, wherein the unlock command comprises a user selected order to dispense the respective fluid from the each one of the plurality of dispensers.

7. The method of claim 6, wherein a graphical user interface displays an icon showing that the plurality of dispensers are unlocked.

8. An apparatus, comprising:
a cassette comprising a plurality of dispense heads, wherein each one of the plurality of dispense heads receives a respective fluid and dispenses the respective fluid;
a graphical user interface (GUI) that receives a lock request and an unlock request during a filling process of the each one of the plurality of dispense heads; and
a processor communicatively coupled to the cassette and the GUI, wherein the processor controls a dispense process of the each one of the plurality of dispense heads in response to the lock request and the unlock request.

9. The apparatus of claim 8, wherein the processor prevents the respective fluid of the each one of the plurality of dispense heads from being dispensed during the filling process in response to the lock request.

10. The apparatus of claim 8, wherein the processor releases the each one of the plurality of dispense heads to dispense the respective fluid in response to the unlock request.

11. The apparatus of claim 10, wherein the each one of the plurality of dispense heads dispenses the respective fluid in a sequence defined by the unlock request.

12. The apparatus of claim 8, wherein the GUI displays a progress of the filling process comprising:
a prompt that highlights a current dispense head that is being filled and receives; and
a confirmation button on the GUI that generates a signal when pressed that the current dispense head is filled.

13. A non-transitory computer readable storage medium encoded with instructions executable by a processor, the non-transitory computer-readable storage medium comprising;
instructions to receive a lock request to lock a plurality of dispensers in a fluid dispensing apparatus;
instructions to display a prompt on a graphical user interface (GUI) that highlights a current dispense head to be filled with a respective fluid;
instructions to receive a confirmation via the GUI that the current dispenser is filled;
instructions to repeat the displaying and the receiving until each one of the plurality of dispensers is filled with the respective fluid;
instructions to receive an unlock command; and
instructions to dispense the respective fluid in accordance with the unlock command.

14. The non-transitory computer-readable storage medium of claim 13, comprising:
instructions to change a status icon on the GUI to a locked status in response to receiving the lock request.

15. The non-transitory computer-readable storage medium of claim 13, comprising:
instructions to change the status icon on the GUI to an unlocked status in response to receiving the unlock command.
